(19) United States
(12) Patent Application Publication
(10) Pub. No.: US 2015/0068420 A1
(43) Pub. Date: Mar. 12, 2015

(54) IN-LINE MAGNETIC COATING INTEGRATED WITH A PRINTING PROCESS

(71) Applicant: MagnetNotes, Ltd., Toledo, OH (US)

(72) Inventors: Randall Boudouris, Sylvania, OH (US); Thomas Stiers, San Antonio, TX (US); Joseph L. Ferrantino, Ware, MA (US); Robert M. Fortunato, Belchertown, MA (US); David G. Haluska, Waukesha, WI (US); Luke Rundquist, Sylvania, OH (US)

(73) Assignee: MagnetNotes, Ltd., Toledo, OH (US)

(21) Appl. No.: 14/022,948

(22) Filed: Sep. 10, 2013

(51) Int. Cl. B41M 5/00

(52) U.S. Cl. CPC B41M 5/0011
USPC 101/407.1; 101/483

(57) ABSTRACT

A unitary method of making a printed magnetic assembly is disclosed, the printed magnetic assembly comprising at least one magnetic layer and at least one printable substrate layer in the form of a sheet or roll, the method comprising the steps of: a) providing a molten magnetic hot melt composition comprising about 70 wt-% to about 95 wt-% of at least one magnetic material and about 5 wt-% to about 30 wt-% of at least one thermoplastic binder; b) directly extruding the magnetic composition at an elevated temperature when it is pliable onto the printable substrate layer with a single screw or double screw extruder to form at least one discrete thin magnetic layer on the printable substrate to form a layered sheet or roll; d) feeding the roll or sheet through a printing press at a speed of about 60 feet/minute to about 1000 feet/minute; e) printing on the printable substrate layer using at least one method selected from the group consisting flexo, gravure, digital and screen printing; and f) permanently magnetizing the magnetic layer, and articles made thereby.

### CROSS-REFERENCE TO RELATED APPLICATIONS

None.

### BACKGROUND OF THE INVENTION

The present invention relates to an inline process for coating, magnetizing and printing on a substrate.

Conventional processes involve coating a substrate with a magnetic composition in one process or calendering. Subsequent processing steps, however, such as printing, are conducted in a separate offline process. For example, see commonly assigned U.S. Pat. Nos. 7,128,798 and 7,338,573, each of which is incorporated by reference herein in its entirety. See also U.S. Pat. No. 5,869,148, the entire content of which is incorporated by reference herein.

It would be advantageous and economical to have a process wherein a substrate can be coated with a magnetic composition at high speeds and subsequently print the substrate in a single inline process.

### SUMMARY OF THE INVENTION

In some embodiments, the present invention relates to a unitary method of making a printed magnetic assembly, the printed magnetic assembly comprising at least one magnetic layer and at least one printable substrate layer in the form of a sheet or roll, the method comprising the steps of: a) providing a molten magnetic composition comprising about 70 wt-% to about 95 wt-% of at least one magnetic material and about 5 wt-% to about 30 wt-% of at least one thermoplastic binder; b) directly extruding the magnetic composition at an elevated temperature when it is pliable onto the printable substrate layer with a single screw or double screw extruder to form a discrete thin magnetic layer on the printable substrate to form a layered sheet or roll; d) feeding the layered sheet or roll through a printing press at a speed of about 60 feet/minute to about 1000 feet/minute; e) printing on the printable substrate layer using at least one method selected from the group consisting flexo, gravure, rotary offset, digital and screen printing; and f) permanently magnetizing the magnetic layer.

### BRIEF DESCRIPTION OF THE DRAWINGS

FIG. 1 is a block diagram illustrating an embodiment of the process according to the invention.

FIG. 2 is a block diagram illustrating another embodiment of the process according to the invention.

### DETAILED DESCRIPTION OF THE INVENTION

The following description is intended for illustrative purposes only, and is not intended as a limit on the scope of the present invention. One of skill in the art will recognize various alternative embodiments and variations of the embodiments which also may be employed herein.

The present invention relates to a unitary method of making a printed magnetic assembly, the printed magnetic assembly comprising at least one magnetic layer and at least one printable substrate layer in the form of a sheet or roll, the method comprising the steps of: a) providing a molten magnetic composition comprising about 70 wt-% to about 95 wt-% of at least one magnetic material, the magnetic material comprising magnetic particles, and about 5 wt-% to about 30 wt-% of at least one thermoplastic binder; b) directly extruding the magnetic composition at an elevated temperature when it is pliable onto the printable substrate layer with a single screw or double screw extruder to form a discrete thin magnetic layer on the printable substrate to form a layered sheet or roll; d) feeding the layered sheet or roll through a printing press at a speed of about 60 feet/minute to about 1000 feet/minute; e) printing on the printable substrate layer using at least one method selected from the group consisting flexo, gravure, rotary offset, digital and screen printing; and f) aligning the magnetic particles by exposing the magnetic layer to a magnetic field. The particles can be aligned by application of the magnetic field at any stage of the process.

In one embodiment, the printing press is a rotogravure press line.

In some embodiments, the layered sheet or roll is fed through a printing press at a speed of about 350 feet/minute to about 500 feet/minute.

In one embodiment, the line speed is about 400 feet/minute +/−50 feet/minute.

In some embodiments, the method further comprises neutralizing of the magnetic layer to reduce or remove any residual magnetic field. The magnetic layer can then be magnetized at a later date, such as after a package has been formed and filled. Aligning the particles horizontally, neutralizing and again applying a magnetic field for permanent magnetization has been found to result in an increase in the magnetic strength of about to about 30%.

Moreover, neutralizing prior to slot die cutting of the coated substrate provides for ease in die cutting and shred trim waste handling.

The method may include the steps of cutting and folding packages in-line, or the packages may be formed at another location and time.

An electronic control system provides process, instrument and electrical controls that are fully integrated with the press print line.

The electronic control system can be employed to control any number of parameters including the temperature of application of the magnetic layer, the thickness of the magnetic layer, the speed at which the rolls or sheets of substrate are fed through the press and so forth.

The electronic system allows for parameters to be varied during application of the magnetic composition to the substrate.

The electronic system may be managed by a processor connected to a network, the network including the hot melt applicator (i.e. the extruder), the roll coating device, the nip roller if present, and the printing press. Each of these parts of the system may be in wireless communication with the network and the processor.

As used herein, the term “magnetic”(when applied to a substrate, article, object, etc.) shall refer to any material which exhibits a permanent magnetic behavior or is readily permanently magnetized.

In some embodiments, the magnetic field is applied to as to align the magnetic particles horizontally.

In some embodiments, a rare earth magnetic roller is employed to align the particles.

Neodynium magnets or samarium cobalt magnets can be employed to align the magnetic particles.

Magnetic materials which are particularly suitable for use herein include the ferrites having the general formula (M²⁺O6Fe₂O₃) MFe₁₂O₁₉ where M represents Ba or Sr.

Other examples of magnetic materials suitable for use herein include a rare earth-cobalt magnet of RCO₅ where R is one or more of the rare earth elements such as Sm or Pr, yttrium (Y), lanthanum (La), cerium (Ce), and so forth.

Other specific examples of magnetic materials include, for instance, manganese-bismuth, manganese-aluminum, and so forth.

The method of the present invention is not limited to any particular magnetic material, and the scope of the invention is therefore not intended to be limited as such. While the above described materials find particular utility in the process of the present invention, other materials which are readily permanently magnetized may also find utility herein.

The magnetic composition suitably includes about 70 wt-% or more of the magnetic material as to have a sufficient attractive force for practical uses. However, it is usually impractical to employ more than 95 wt-% of the magnetic material because of production concerns, and also because of the difficulty of retaining more than this in the binder material. Furthermore, including more than about 95 wt-% of the magnetic material may lead to a rougher surface. The magnetic material is often supplied in a powder form.

The magnetic strength of the finished product is a function of the amount of magnetic material or powder in the mix, the surface area, thickness, and method of magnetization (e.g. whether it is aligned or not).

The thermoplastic material, often referred to in the industry as a thermoplastic binder, suitable for use in the process of the present invention may include any polymeric material that is readily processable with the magnetic material on, for instance, the thermoplastic or hot melt processing equipment as described in detail below. Such thermoplastic materials include both thermoplastic elastomers and non-elastomers or any mixture thereof.

The thermoplastic composition may be selected based on, for one, the type of printable substrate which is being used, and the adhesion obtained between the thermoplastic composition and the printable substrate.

Examples of thermoplastic elastomers suitable for use herein include, but are not limited to, natural and synthetic rubbers and rubbery block copolymers, such as butyl rubber, neoprene, ethylene-propylene copolymers (EPM), ethylene-propylene-diene polymers (EPDM), polyisobutylene, polybutadiene, polyisoprene, styrene-butadiene (SBR), styrene-butadiene-styrene (SBS), styrene-ethylene-butylene-styrene (SEBS), styrene-isoprene-styrene (SIS), styrene-isoprene (SI), styrene-ethylene/propylene (SEP), polyester elastomers, polyurethane elastomers, to mention only a few, and so forth and mixtures thereof. Where appropriate, included within the scope of this invention are any copolymers of the above described materials.

Examples of suitable commercially available thermoplastic elastomers such as SBS, SEBS, or SIS copolymers include KRATON□ G (SEBS or SEP) and KRATON□ D (SIS or SBS) block copolymers available from Kraton Polymers; VECTOR® (SIS or SBS) block copolymers available from Dexco Chemical Co.; and FINAPRENE® (SIS or SBS) block copolymers available from Atofina.

Some examples of non-elastomeric polymers include, but are not limited to, polyolefins including polyethylene, polypropylene, polybutylene and copolymers and terpolymers thereof such as ethylene vinyl acetate copolymers (EVA), ethylene n-butyl acrylates (EnBA), ethylene methyl(meth) acrylates including ethylene methyl acrylates (EMA), ethylene ethyl(meth) acrylates including ethylene ethyl acrylates (EEA), interpolymers of ethylene with at least one C₃ to C₂₀ alphaolefin, polyamides, polyesters, polyurethanes, to mention only a few, and so forth, and mixtures thereof. Where appropriate, copolymers of the above described materials also find utility herein.

Examples of polymers useful herein may be found in U.S. Pat. No. 6,262,174 incorporated by reference herein in its entirety. Polymeric compositions exhibiting high hot tack have been found to be particularly suitable for use herein. Hot tack is a term of art known to those of ordinary skill.

Examples of commercially available non-elastomeric polymers include EnBA copolymers available from such companies as Atofina under the tradename of Lotryl® available from Arkema in the King of Prussia, Pa., from ExxonMobil Chemical in Houston, Tex. under the tradename of Escorene™, from DuPont de Nemours & Co. in Wilmington, Del. under the tradename of Elvaloy®; EMA copolymers available from ExxonMobil Chemical under the tradename of Optema™; EVA copolymers are available from DuPont™ under the tradename of Elvax® and from LyondellBlassell in Houston, Tex. under the tradename of Ultrathene® to name only a few.

Polyolefins or polyalphaolefins can be employed herein, or copolymers or terpolymers thereof. Examples of useful polyolefins include, but are not limited to, amorphous (i.e. atactic) polyalphaolefins (APAO) including amorphous propylene homopolymers, propylene/ethylene copolymers, propylene/butylene copolymers and propylene/ethylene/butylene terpolymers; isotactic polyalphaolefins; and linear or substantially linear interpolymers of ethylene and at least one alpha-olefin including, for instance, ethylene and 1-octene, ethylene and 1-butene, ethylene and 1-hexene, ethylene and 1-pentene, ethylene and 1-heptene, and ethylene and 4-methyl-1-pentene and so forth. In some embodiments, it may be preferable to employ a small amount of another polymer in combination with the polyalphaolefin such as maleic anhydride grafted polymers which have been used to improve wetting and adhesion. Other chemical grafting can be used, but maleic anhydride is by far the most common. Usually only a few percent in grafting (1-5%) are used and most tend to be ethylene or propylene copolymers.

The terms “polyolefin” and “polyalphaolefin” are often used interchangeably, and in fact, are often used interchangeably to describe amorphous polypropylenes (homo-, co- and terpolymers).

The term “alpha” is used to denote the position of a substituting atom or group in an organic compound.

As used herein, the terms “copolymer” and “interpolymer” shall be used to refer to polymers having two or more different comonomers, e.g. copolymer, terpolymer, and so forth.

Examples of commercially available amorphous polyolefins suitable for use herein include those available under the tradename of Rextac® from REXtac® LLC in Odessa, Tex. including polypropylene homopolymers, propylene/ethylene copolymers and propylene-butene copolymers; Vestoplast® APAOs available from Evonik Industries in Essen, Germany including homopolymers and copolymers, as well as terpolymers of propylene/ethylene/butene; as well as those available from Rexene Chemical and those available under the tradename of Eastoflex® available from Eastman Chemical Co. in Kingsport, Tenn.

Examples of copolymers of a polyolefin and at least one alpha-olefin include metallocene catalyzed polyolefins (interpolymers of ethylene and at least one alphaolefin) commercially available from Exxon under the tradename Exxact®, and from the Dow Chemical Co. in Midland, Mich. Elastomers under the tradename Engage.

Any of the polymeric materials useful herein may be used in combination with one another. Furthermore, other polymeric materials not specifically described herein also find utility in the present invention. The list described above is intended for illustrative purposes only, and is not intended to limit the scope of the present invention. One of skill in the art would understand that there are vast numbers of polymeric materials available that may find utility herein.

In some embodiments, at least one ethylene vinyl acetate copolymer is employed and combination of ethylene vinyl acetate copolymers have been found to be of particular utility.

Thermosetting polymers can also be employed herein.

Tackifying resins are available from numerous sources including many of the companies described above, and include, for instance, hydrocarbon tackifying resins such as those available from Eastman Chemical Co. under the tradename of Eastotac®; Escorez® petroleum hydrocarbon resins available from ExxonMobil Chemical; Piccotac® polyterpene resins available from Eastman Chemical Co. and Piccolyte® polyterpene resins available from Pinova in Brunswick, Ga.; Foral® hydrogenated rosins and rosin ester resins available from Pinova; Wingtac® petroleum hydrocarbon resins available from Cray Valley in Exton, Pa.; Regalrez® hydrocarbon resins and Regalite® hydrogenated aromatic resins available from Eastman Chemical Co.; and so on and so forth.

Plasticizers are available from many sources and include plasticizing oils, for instance. Plasticizing oils are often petroleum based and are available from various petroleum companies.

Waxes may also be optionally added to the compositions to lower the melt viscosity and/or change rheological characteristics.

Other optional ingredients include, but are not limited to, antioxidants, dyes or pigments, UV agents, and so forth. Such optional ingredients are known to those of skill in the art and are typically added in low concentrations which do not adversely affect the physical characteristics of the composition.

These lists of materials described above are intended for illustrative purposes only, and are by no means exclusive of the materials which may be employed in the magnetic composition herein, and as such is not intended as a limit on the scope of the invention herein.

A particularly suitable composition includes 85.95% Starbond® HM403 ferrite powder; Hoosier Magnetics, Inc., Ogdensburg, N.Y., 4.86% Escorene® UL7710 ethylene vinyl acetate copolymer (28% vinyl acetate, 420 melt index, 39,000 cPs viscosity); ExxonMobil Chemical Co., Houston, Tex., 6.24% MVO 2528 ethylene vinyl acetate copolymer (27.5% vinyl acetate, 2500 melt index, 7,000 cPs viscosity), ExxonMobil Chemical Co., 2.77% UL7840; C ethylene vinyl acetate copolymer (28% vinyl acetate, 43 melt index, 345,000 cPs viscosity); ExxonMobil Chemical Co. 0.12% Irganox® 1010 antioxidant; Ciba Specialty Chemicals, Tarrytown, N.Y. and 0.06% Benefos® 1680 antioxidant; Mayzo, Inc., Norcross, Ga. employed at a thickness of about 254-264 microns or 0.0100-0.0104″.

The magnetic material and the thermoplastic binder and/or other ingredients are blended at elevated temperatures using standard thermoplastic mixing equipment such as extruders, Baker Perkins, Banbury mixers, single or twin screw extruders, Farrell Continuous mixers, and high shear mixing equipment.

The mixture may be compounded and made into a form, such as slats, pellets or any form known in the art suitable for feedstock for extrusion or other melt processing equipment, which is then delivered to the coating company. The coating company may then use a high pressure single screw extruder, or other processing equipment to melt and pressurize the mixture, to force it through an application head such as a slot die, rotary screen head, or other such application head, at the coating station. Thus, the extruder or other hot melt equipment supplies the resultant magnetic composition directly to the application head. During extrusion or other melt processing of the magnetic composition, the temperature may be high enough that the composition is considered to be molten, i.e. in melted or liquid form.

In an alternative embodiment of the present invention, various ingredients may be supplied to the extruder in individual pellets, slats, and so forth. For instance, if more than one thermoplastic binder material is employed, they do not have to be supplied as a mixture already in pellet or slat form. They may each be supplied in pellet or slat form individually, for example.

In one embodiment, pellets are employed.

Coating companies can use a variety of application processes known in the art. Examples of application processes useful in applying the magnetic composition to the printable substrate include, but are not limited to, slot die coating, roll coating or reverse roll coating, knife-over-roll gravure and reverse direct gravure, wire rod coating, air-knife coating, slot-orifice coating, screen printing with a hot screen, and so forth.

In one embodiment of the present invention, slot die coating is used in combination with a single screw extruder.

Due to the high amount of magnetic particles in the magnetic compositions, slot dies can wear out extremely fast. It has been found that by using tungsten carbide or zirconium oxide on the coating edge of the slot dies, the useful lifetime of the slot die can be greatly increased by up to several months.

In some embodiments, a plurality of mini slot die heads are employed to apply a series of equally spaced stripes of magnetic materials to the substrate. These slot die heads may vary in length from as little as 0.25 inches.

In one embodiment, four slot die heads apply magnetic stripes 1 inch wide.

In one embodiment, four slot die heads apply magnetic stripes 1 inch and 8 mils thick across a 32″ paper web.

A coating method referred to in the art as flex-o-press may also be employed. The term “flex-o-press” as used herein, generally refers to a four roll coating method by which a first roll which is heated, and typically turns at a speed which is half of the second roll. The second roll carries the thermoplastic/magnetic mixture. A third roll is a roll-plate roll which is a silicone rubberized roll and may have a patterned surface with raised areas for application of the magnetic composition of the present invention to the printable substrate in a predetermined pattern. This roll comes into light contact with the second roll and then transfers the thermoplastic/magnetic mixture to a fourth roll. See Roll Coating by R. T. Schorenberg, Modern Plastic Encyclopedia, 1984 1985, pp. 202 203, which is incorporated herein by reference in its entirety. Another useful reference is Coatings Technology Handbook, 2nd Edition, Satas and Tracton, Marcel Dekker, Inc., 2001 also which is incorporated by reference herein in its entirety. Desirably, the processing equipment includes a chill roll for increasing the speed with which the resultant magnetic composition, including at least the magnetic material and a thermoplastic binder, cools and sets. This is advantageous for more rapidly processing the resultant composition into rolls or sheets, for instance.

The process according to the invention can be employed to make any printed substrate and finds particular utility for those substrates formed from paper, paper products or pasteboard. However, other materials can be employed as well including, but not limited to, plastic or polymeric materials, metal, release liners such as silicone release liner, textiles or fabrics, and so forth. Combinations of any of the substrates may also be employed.

In particular embodiments, the substrate is a layered or laminated substrate and includes paper, paper products or pasteboard and a foil wrap.

The application temperature required may depend on numerous factors including the melting temperature of the thermoplastic binder, the viscosity of the resultant magnetic composition, and so forth. The melting temperature and viscosity may vary depending not only on the type of binder used, but on the various other ingredients which may be employed in the magnetic composition as described above. The higher the viscosity or melting temperature, the higher the temperature that may be required to successfully apply the magnetic composition. This of course also depends on the application equipment being employed. In general, thermoplastic materials are applied at temperatures of about 275° F. to about 375° F. (about 135° C. to about 190° C.), although some may be applied at higher or lower temperatures. For instance, very low viscosity thermoplastics may be applied at temperatures of as low as about 190° F. (about 90° C.). Some may be applied at temperatures as high as about 400° F. (about 205° C.), or higher, for instance polyamide materials are often applied at temperatures of about 400° F. Temperatures used, can even exceed 650° F., however. However, for most thermoplastic materials higher temperatures lead to more rapid degradation of the material. An often used application temperature range is about 325° F. to about 375° F. (about 160° C. to about 190° C.), with 350° F. (about 175° C.) being very common.

The temperature should be sufficient to lower the viscosity of the thermoplastic material to allow the thermoplastic material to sufficiently adhere to the printable substrate. This may involve penetration into, or “wet out” of the substrate surface to which it is being applied. The thermoplastic material must be sufficiently adhered to the substrate so that delamination from the substrates does not occur.

Using the method of the present invention, the resultant magnetic composition may be advantageously applied in a thin layer of about 0.002 inches to about 0.030 inches (about 50 μ to about 765μ; about 2 mils to about 30 mils), suitably about 0.002 inches to about 0.020 inches (about 50μ to about 510μ; about 2 mils to about 20 mils) and most suitably about 0.002 inches to about 0.012 inches (about 50l μto about 305μ; about 2 mils to about 12 mils thick. The present invention allows for application of a thinner layer of the binder/magnetic mixture. Previous extrusion and calendering methods, in contrast, did not allow for magnetic layers of less than about 4 mils to about 8 mils, and often more than 10 mils.

In one embodiment, the magnetic layer is 8 mils thick.

The thickness of the magnetic layer can be accurately and precisely controlled in real time using the present invention. A nuclear backscatter device or a laser measuring device can be employed in-line. A nuclear backscatter device measures the density of the polymeric magnetic composition. This allows for accurate real time measurements as to the thickness of the magnetic layer.

Once the entire magnetic assembly has been produced in roll or sheet form, the desired shapes may be cut, punched, stamped, or so forth from the assembly, either at the point of manufacture of the magnetic material, or by those to which the magnetic assembly is supplied as desired. Laser cutting is one example of a method by which various articles may be formed from the sheet or web.

The sheets or rolls are then fed through a printing press such as flexo, gravure, rotary offset, digital or screen printing presses.

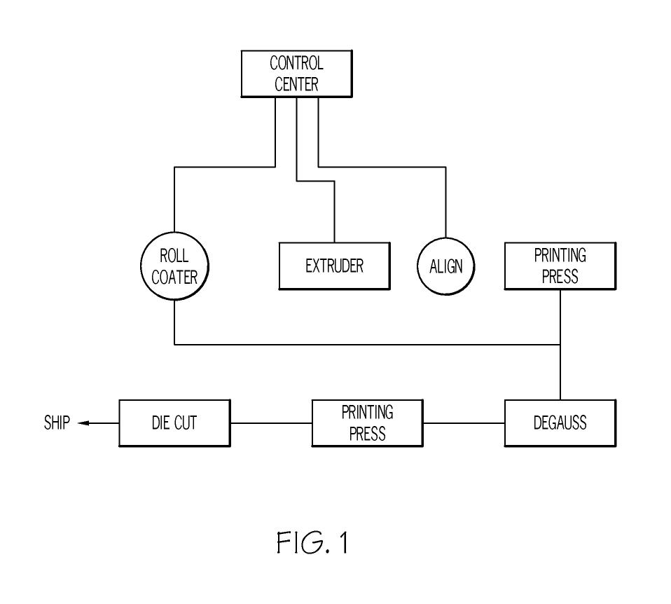

FIG. 1 is a block diagram illustrating one embodiment of a method according to the present invention. A substrate is fed to the extruder via a roll coater wherein the magnetic composition is applied using a slot die head or multiple slot die heads such as mini slot die heads as disclosed. Alignment of the magnetic particles is accomplished almost simultaneously with extrusion. The substrate is then fed through the printing press, followed by neutralizing of the magnetic composition. The substrate can then optionally be fed through another printing press, or fed back through the same printing press. The substrate is die cut and then shipped off for formation into a package. The die cut substrate can optionally be scored to facilitate folding. Once the package has been formed, the magnetic composition is once again subjected to a magnetic field for magnetization.

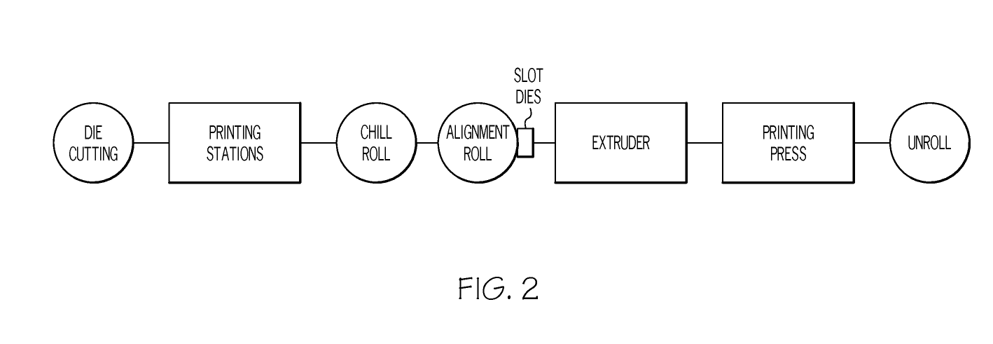

FIG. 2 is a block diagram illustrating an alternative embodiment of a method according to the invention. In this embodiment, the substrate is unrolled and fed through a printing press followed by extrusion of the magnetic composition onto the substrate using a slot die heads. The magnetic material is then aligned and the substrate fed through a chill roll, another printing station and subsequently is subsequently die cut.

The above examples are for illustrative purposes only, and not limiting to the scope of the present invention. The method steps can be varied as is understood by those of ordinary skill in the art.

The present invention finds utility in making any magnetized, printed substrate.

In some embodiments, the printed substrates are packages, such as packages for consumable food items. In particular, the present invention finds utility for reclosable packages wherein it is desired that the contents not spill out of the package.

The packages may be permanently sealed at all but one end wherein the package is opened and a reclosable seal is formed via the use of a magnetic region. The permanent seals may be formed using any conventional method known in the art including by folding or with an adhesive, for example.

Other examples of printed material include, but are not limited to, promotional pieces, greeting cards, postcards, magnetic business cards, appointment reminder cards, announcements, advertisements, coupons, labels, calendars, picture frames, and so forth which have a magnetic surface joined to a printed surface which may be self-adhered or self-sticking to a metallic surface for display.

The present method is advantageous because the substrate can be coated and printed in a single inline process.

Previous methods, in contrast, printed the coated substrates off-line which is less efficient and more costly.

One of ordinary skill in the art will recognize that these are only examples of numerous sizes and shapes of packages which can be employed herein without deterring from the scope of the present invention.

Attached as an appendix is more information on this process.

The description provided herein is not to be limited in scope by the specific embodiments described which are intended as single illustrations of individual aspects of certain embodiments. The methods, compositions and devices described herein can comprise any feature described herein either alone or in combination with any other feature(s) described herein. Indeed, various modifications, in addition to those shown and described herein, will become apparent to those skilled in the art from the foregoing description and accompanying drawings using no more than routine experimentation. Such modifications and equivalents are intended to fall within the scope of the appended claims.

All publications, patents and patent applications mentioned in this specification are herein incorporated by reference in their entirety into the specification to the same extent as if each individual publication, patent or patent application was specifically and individually indicated to be incorporated herein by reference. Citation or discussion of a reference herein shall not be construed as an admission that such is prior art.

1. A unitary method of making a printed magnetic assembly, the printed magnetic assembly comprising at least one magnetic layer and at least one printable substrate layer in the form of a sheet or roll, the method comprising the steps of: a) providing a molten magnetic hot melt composition comprising about 70 wt-% to about 95 wt-% of at least one magnetic material and about 5 wt-% to about 30 wt-% of at least one thermoplastic binder; b) directly extruding the magnetic composition at an elevated temperature when it is pliable onto a moving printable substrate layer with a single screw or double screw extruder to form at least one discrete thin magnetic layer on the printable substrate to form a layered sheet or roll; d) feeding the roll or sheet through a printing press at a speed of about 60 feet/minute to about 1000 feet/minute; e) printing on the printable substrate layer using at least one method selected from the group consisting flexo, gravure, digital and screen printing; and f) permanently magnetizing the magnetic layer.

2. The method of claim 1 further comprising the step of neutralizing the permanently magnetized magnetic layer to remove any remnant magnetic field.

3. The method of claim 1 wherein the printable substrate comprises a member selected from the group consisting of paper, paper products, paste board, polyolefin or vinyl.

4. The method of claim 3 wherein the printed substrate is a package.

5. The method of claim 4 wherein said printed substrate comprises at least one member selected from the group consisting of paper, paper products or paste board and foil wrap.

6. The method of claim 4 wherein the package is a rectangular or square package, the package is permanently sealed on an end and each side, the other end comprising a resealable opening, the resealable opening comprising the at least one discrete thin magnetic layer having a first magnetic field and a second discrete thin magnetic layer applied to the opposing side of the package having a second magnetic field opposite that of the first magnetic field or that is magnetically receptive to the first magnetic field.

7. The method of claim 6 wherein the package is for a consumable product.

8. The method of claim 6 wherein the package is sized and configured for a food item selected from the group consisting of chewing gum, candy, mints, tobacco and cereal.

9. The method of claim 1 wherein said magnetic hot melt composition comprises at least one thermoplastic binder that is ethylene vinyl acetate.

10. The method of claim 1 wherein said magnetic hot melt composition comprises about 80 wt-% to about 92 wt-% of at least one magnetic material and about 5 wt-% to about 20 wt-% of at least one thermoplastic polymer.

11. The method of claim 1 wherein said magnetic hot melt composition comprises about 85 wt-% to about 95 wt-% of at least one magnetic material and about 5 wt-% to about 15 wt-% of at least one thermoplastic polymer.

12. The method of claim 1 wherein said magnetic hot melt composition comprises about 80 wt-% to about 95 wt-% of at least one magnetic material and about 5 wt-% to about 15 wt-% of at least one thermoplastic polymer.

13. The method of claim 1 wherein said feeding the roll or sheet through a printing press at a speed of about 350 feet/minute to about 500 feet/minute.

14. The method of claim 1 further comprising measuring the thickness of the magnetic layer in real time.

15. The method of claim 14 wherein the measuring of the thickness of the magnetic layer is conducted with a nuclear backscatter device or a laser measuring device.

16. A continuous system for preparing a thin film printed magnetic assembly, the magnetic assembly comprising at least one printed substrate layer and at least one magnetic layer, the system comprising:
an extruder for applying the magnetic layer;
at least one slot die head in communication with the extruder;
a moving substrate, the extruder supplies the slot die head with a polymeric magnetic composition comprising at least one polymer and at least one magnetic material, the magnetic material comprising magnetic particles, the slot die head applies the polymeric magnetic composition onto said substrate to form the magnetic layer onto the substrate;
a magnetic field, the substrate comprising the magnetic layer is advanced through the magnetic field, exposure to the magnetic field aligns said magnetic particles;
a printing press, the substrate is advanced through the printing press; and
a controller;
wherein the extruder and the printing press are in operative communication with the controller, so that the thickness of the magnetic layer and the speed of the moving substrate can be controlled by the controller.

17. The system of claim 16 further comprising a measuring device, the measuring device selected from a laser backscatter device or a laser measuring device, the measuring device configured to determine the thickness of the magnetic layer, and to communicate the thickness to the controller.

18. The system of claim 16 wherein the communication is wireless.

19. The system of claim 16 comprising a speed of about 60 feet/minute to about 1000 feet/minute.

20. The system of claim 16 comprising a speed of about 350 feet/minute to about 500 feet/minute.
